(19) United States
(12) Patent Application Publication
(10) Pub. No.: US 2008/0172695 A1
(43) Pub. Date: Jul. 17, 2008

(54) Media selection

(75) Inventors: Charles Migos, San Francisco, CA (US); Ron Morris, San Francisco, CA (US); Davis Sloo, Menlo Park, CA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/650,167

(22) Filed: Jan. 5, 2007

(51) Int. Cl. G06F 13/00

(52) U.S. Cl. 725/45

(57) ABSTRACT

Various technologies for selecting media (e.g., television media) are described. A media selection method displays a tool for selecting a category, such as a television genre, to a user. Upon receiving a user selection, the selected category having a number of channels is visually illustrated on a channel selection spectrum (e.g., a circular arc channel selection spectrum). For example, if the selected category is sports, then a number of channels corresponding to sports channels are highlighted on the channel selection spectrum. Moreover, in one example, the channel selection spectrum works in conjunction with a touchscreen device. Thus, a user can navigate with his or her finger to quickly select and browse the available channels. Also, optionally, non-highlighted channels are automatically bypassed to assist user navigation. Additionally, upon receiving user selection of a channel, in one example, the media content corresponding to the selected channel is played.

### BACKGROUND

The amount of available television content has increased appreciably in recent years. Not only have domestic channels grown in numbers, a wide variety of foreign channels are also available to viewers via satellite transmission.

Because of this, nowadays viewers often have access to hundreds of television channels providing a variety of viewable content from different genres (e.g., sports, movies, cooking shows, cartoons, science fiction . . . etc.). In addition, a genre may itself include a significant number of channels. For example, under the sports genre, there may be a channel dedicated to basketball, a channel dedicated to baseball, a channel dedicated to football, a channel dedicated to golf, . . . etc.

Conventionally, a user watching television uses a numeric based remote control to select television content. A typical numeric based remote control has numeric keys and in addition a channel up key and a channel down key. By entering a combination of numbers (e.g., 12 for channel 12) with the numeric keys, a television viewer is directed to the desired channel. Also, the channel up key and the channel down key allow the viewer to browse through available channels in a sequential fashion.

However, although the numeric based remote control was sufficient in the past when the number of television channels readily available was much lower, for a variety of reasons, it is not as efficient for navigating the large number of channels available today. For example, a viewer may be only interested in viewing television content belonging to a particular genre, such as television channels showing movies.

However, in such a scenario, locating particular television channels of a specific genre may be challenging when the total number of channels is significantly large. In response, conventionally, some users access electronic programming guides (EPGs) that aid in locating certain television channels of interest. Nevertheless, because EPGs typically encompasses a large amount of information, it is inherently complex. Hence, in order to use EPGs efficiently, a user may need to have a certain degree of prior knowledge regarding specific channels. For instance, a user may need to know a channel name, a show time, or a program name in order to find a channel of interest. Without prior knowledge, a user may find EPGs to be confusing and daunting to use.

Aside from EPGs, a user may also just use a traditional numeric based remote control to browse. However, in such a scenario, the user would either have to (1) browse channel by channel for available movie channels or; (2) if the user has a list of movie channels, then enter a set of channel numbers to see one movie channel, enter another set of channel numbers to see another movie channel, and so on. Thus, given many channels to choose from, such traditional numeric based remote control may quickly become tedious for a user.

Moreover, because a user is not likely to have the detailed layout of a numeric based remote control committed to memory, conventional numeric based remote controls are difficult to use in low light conditions. For instance, a user may find it irritating to punch in channel numbers when visibility is low.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various technologies for selecting media (e.g., television media) are described. A media selection method displays a tool for selecting a category, such as a television genre, to a user. Upon receiving a user selection, the selected category having a number of channels is visually illustrated on a channel selection spectrum (e.g., a circular arc channel selection spectrum). For example, if the selected category is sports, then a number of channels corresponding to sports channels are highlighted on the channel selection spectrum. Moreover, in one example, the channel selection spectrum works in conjunction with a touchscreen device. Thus, a user can navigate with his or her finger to quickly select and browse the available channels. Also, optionally, non-highlighted channels are automatically bypassed to assist user navigation. Additionally, upon receiving user selection of a channel, in one example, the media content corresponding to the selected channel is played.

Embodiments allow a user that is interested in browsing various channels of a particular category to easily navigate through channels belonging only in the particular category and not be encumbered by channels from uninterested categories. Also, once the user is focused in on the particular category of media, the user can efficiently navigate through (e.g., navigate via a radial motion) the different channels of the particular category by using the channel selection spectrum.

### BRIEF DESCRIPTION OF THE DRAWINGS

FIG. 1 illustrates one implementation of a media selection interface.

FIG. 2 illustrates one implementation of a linear media selection interface.

FIGS. 3A and 3B jointly illustrate one implementation of a television selection interface in operation.

FIGS. 4A and 4B jointly illustrate one implementation of a television selection interface and a display in operation.

FIGS. 5A and 5B jointly illustrate one implementation of a music selection interface in operation.

FIG. 6 illustrates an example flowchart for a method of media selection.

FIG. 7 illustrates an example flowchart for a method of television channel selection.

FIG. 8 illustrates an example system for delivering VOD content from a VOD center to a user.

FIG. 9 illustrates an example touch screen remote control device.

FIG. 10 illustrates an example computing device for implementing the claimed subject matter.

FIGS. 11A and 11B illustrate a perspective view and a side view respectively of an example oblate spheroidal media selection remote control device.

FIGS. 12A and 12B illustrate a perspective view and a side view respectively of an example circular disk shaped media selection remote control device.

### DETAILED DESCRIPTION OF THE DRAWINGS

Reference will now be made in detail to various embodiments, examples of which are illustrated in the accompanying drawings. While the claimed subject matter will be described in conjunction with these embodiments, it will be understood that they are not intended to limit the claimed subject matter to these embodiments. On the contrary, the claimed subject matter is intended to cover alternatives, modifications and equivalents, which may be included within the spirit and scope of the claimed subject matter as defined by the appended claims. Furthermore, in the following detailed description of the present claimed subject matter, numerous specific details are set forth in order to provide a thorough understanding of the present claimed subject matter. However, it will be evident to one of ordinary skill in the art that the present claimed subject matter may be practiced without these specific details. In other instances, well known methods, procedures, components, and circuits have not been described in detail as not to unnecessarily obscure aspects of the claimed subject matter.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. A procedure, logic block, process . . . etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of usage, to refer to these signals as bits, bytes, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present claimed subject matter, discussions utilizing terms such as “displaying,” “receiving,” “transitioning,” “playing,” “highlighting,” “magnifying” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

As previously mentioned, a traditional numeric based remote control is not efficient for navigating through a large number of television channels. Among other disadvantages, traditional numeric based remote controls do not afford a television viewer an easy way to browse through different channels of a particular genre (e.g., movie channels). Moreover, EPGs are complex and can be daunting to new users.

In contrast, embodiments illustrate user-friendly interfaces that provide a television viewer ways to efficiently browse through different television channels of various genres in which the television viewer may have an interest. In one example, a method for selecting a television channel includes displaying a graphical user interface (GUI) having a genre selection tool, such as a television genre selection tool. The genre selection tool enables a user to easily select a particular television genre of interest. For example, a user can use the genre selection tool to select the sports genre. Also, a channel selection spectrum representing a number of channels is displayed. The channel selection spectrum can be displayed on a television screen, a computer screen, and/or on a touchscreen of a touchscreen remote control device. The channel selection spectrum visually illustrates each of the available channels as an individual line on the channel selection spectrum. Once a user has selected a genre, the channel selection spectrum automatically highlights all the channels classified under the selected genre. The highlighting enables a user to quickly browse through all the channels of the selected genre. Furthermore, all the other channels that do not belong under the selected genre are automatically bypassed to assist user navigation.

Channel selection with the channel selection spectrum is more intuitive than the traditional numeric based remote control. This is due in part because once a user has selected a particular genre, the channels belonging to the selected genre are automatically highlighted, which makes it and are easy for a user to see the interested channels and does not require prior knowledge from a user. In contrast, the traditional numeric based remote control provides no information to a user as to where related channels are located.

Once user selection for a particular channel is received, the corresponding television content is displayed. In at least this way, embodiments allow a user that is interested in browsing various channels of a particular genre to easily navigate through only channels belonging to the genre of interest (e.g., sports) and not to be encumbered by channels from other genres (e.g., cooking shows, soap operas . . . etc.). Once the user is focused in on the particular genre of interest, the user can efficiently navigate through (e.g., navigate via a radial motion) the different channels of the particular genre by using the channel selection spectrum.

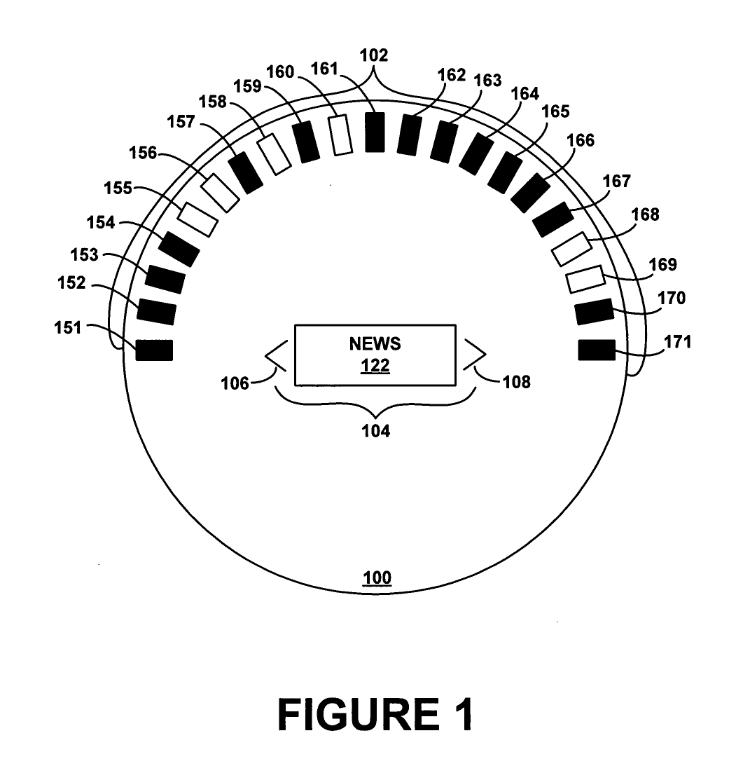

FIG. 1 illustrates one implementation of a media selection interface 100. Media selection interface 100 includes a category selection component 104 and a circular arc multimedia asset selection spectrum 102. In one example embodiment, circular arc multimedia asset selection spectrum 102 is configured to receive radial motion based selection from a user. Category selection component 104 includes a category display portion 122 for displaying the selected category (e.g., news), a first category selection arrow 108 for changing categories in a first direction (e.g., forward direction), and a second category selection arrow 106 for changing categories in a second direction (e.g., reverse direction). In one example, by selecting first category selection arrow 108, the selected category is changed from news to sports.

Furthermore, circular arc multimedia asset selection spectrum 102 includes a number of discrete intervals that represent channels. Specifically, with reference still to FIG. 1, circular arc multimedia asset selection spectrum 102 includes discrete intervals 151-171 corresponding respectively to channels 151-171.

Also, although media selection interface 100 is shown and described as having certain numbers and types of elements, embodiments are not so limited; that is, media selection interface 100 may include elements other than those shown, and may include more than one of the elements that are shown. For example, although media selection interface 100 is shown here as having 21 discrete intervals that correspond to 21 channels, media selection interface 100 can include greater or fewer number of discrete intervals that represent channels. Furthermore, although media selection interface 100 is illustrated under the context of television channels, embodiments are not so limited. Embodiments are applicable to music media, Video On Demand (VOD) media, and other types of media.

Referring still to FIG. 1, in one embodiment, the category is set to news. In accordance to this setting, only the discrete intervals that correspond to news channels are highlighted. In one example, discrete intervals 155, 156, 158, 160, 168, and 169 correspond to news channels and are highlighted. Other discrete intervals, such as discrete intervals 151, 152, 153, and 154 do not correspond to news channels and are left un-highlighted. In one example, a user can change category by using a category selection arrow, such as a category selection arrow 106 or category selection arrow 108. By selecting category selection arrow 106, a different category, such as sports, is selected. Correspondingly, discrete intervals that correspond to sports channels are highlighted, and the discrete intervals that correspond to news channels are no longer highlighted.

In one example, the shape of the circular arc multimedia asset selection spectrum 102 allows a user to easily navigate through the different channels with a radial motion. The media selection interface 100 works in conjunction with a touchscreen remote control device. A user can move his or her finger along the portions of the touchscreen remote control device that displays the circular arc multimedia asset selection spectrum 102 to navigate through the different channels. For example, a user can provide a circular dialing motion with the user's finger or thumb to browse through the channels of the selected category. Among other advantages, the circular arc multimedia asset selection spectrum 102 provides a more efficient and more ergonomic interface.

The media selection interface 100 works in conjunction with a display device (e.g., a television display and/or a computer display). Specifically, in addition to being displayed on a touchscreen surface of a remote control device, the media selection interface 100 is also displayed on a television screen. While the touchscreen surface, because of its limited display area, may show an abbreviated (e.g., incomplete) version of a media selection interface 100, the television screen may show an unabbreviated (e.g., complete) version of the media selection interface 100. As a television display is typically larger, by displaying the media selection interface 100 on a television screen, a user may be able to see and navigate through different channels more easily.

As a user moves his or her finger or thumb along the circular arc multimedia asset selection spectrum 102, non-highlighted discrete intervals (e.g., discrete intervals 151, 152, 153, 154, 157, 159, 161, 162, 163, 164, 165, 166, 167, 170, and 171) are automatically bypassed. In other words, as the user is moving his or her finger along the circular arc multimedia asset selection spectrum 102, all discrete intervals aside from discrete intervals 155, 156, 158, 160, 168, and 169 are automatically bypassed. In this way, a user can more efficiently browse channels of interest and not waste time with uninterested channels (e.g., discrete intervals 151, 152, 153, 154, 157, 159, 161, 162, 163, 164, 165, 166, 167, 170, and 171).

A user moving his or her finger along the circular arc multimedia asset selection spectrum 102 is first directed to the highlighted discrete interval 155. The discrete intervals 151, 152, 153, and 154 are automatically bypassed. As the user continues to move his or her finger pass highlighted discrete interval 155, the user is next directed to highlighted discrete interval 156. If the user continues to move in a clockwise manner, discrete interval 157 is bypassed and the user is directed to highlighted discrete interval 158, and so on and so forth until the user has browsed through all the available channels.

In one embodiment, the media selection interface 100 has a loop back function such that if a user “dials” through the last available channel, the user is automatically directed back towards the first available channel. In one example, as a user “dials” pass highlighted channel 169, the user is automatically directed to channel 155.

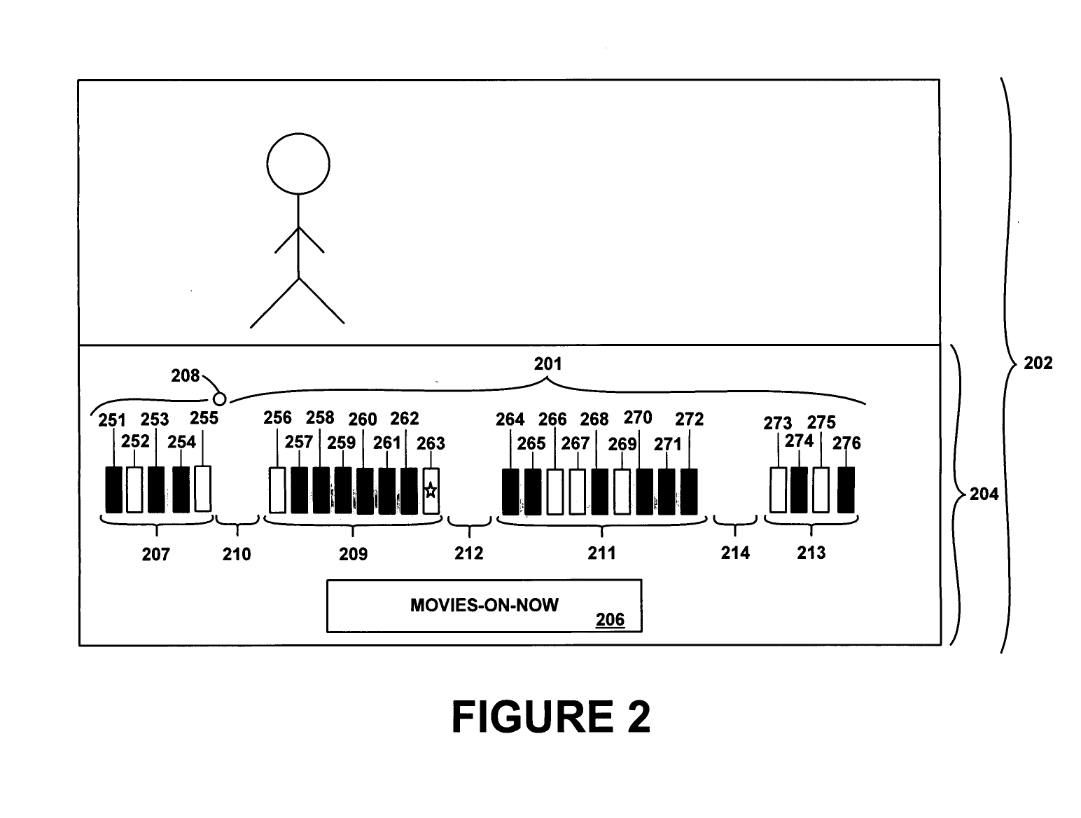

FIG. 2 illustrates one implementation of a linear media selection interface 204. FIG. 2 illustrates a display 202 (e.g., a computer display, a television display, and/or a touchscreen device display). Linear media selection interface 204 is displayed on display 202 and includes a category display portion 206 (e.g., movies-on-now), a current channel indicator dot 208 pinpointing the currently selected channel, and a linear channel selection spectrum 201. Linear channel selection spectrum 201 is configured to receive left/right motion based selection from a user. In some embodiments, linear channel selection spectrum 201 is displayed vertically (as opposed to the horizontal orientation shown in FIG. 2) and configured to receive up/down motion based selection from a user. Media selection interface 204 can work in conjunction with a touch pad, and left/right motion from a user is received via the touch pad and translated into a selection command (e.g., a generally rightward motion from a user is translated as a command to navigate to a channel to the right of the currently selected channel.). A user can move his or her finger along the portions of the touchscreen surface that displays the linear channel selection spectrum 201 to navigate through the different channels. A user can use a remote control device, including but limited to a touchscreen remote control device, to control a linear media selection interface 204 displayed on a television display and/or a computer display.

Furthermore, linear channel selection spectrum 201 includes a number of discrete intervals that represent channels. Specifically, with reference still to FIG. 2, linear channel selection spectrum 201 includes discrete intervals 251-276 corresponding to channels 251-276.

In one embodiment, the discrete channels are divided into channel islands 207, 209, 211, and 213. Also, gaps 210, 212, and 214 are present to provide cues to a user so that the user has visual and spatial reference as to the location of the channel islands 207, 209, 211, and 213. A channel island is utilized to organize and group channels. Channel island 207 is the music channels block, channel island 209 is the movies block, channel island 211 is the pay-per-view block, and channel island 213 is the cartoon block.

Referring still to FIG. 2, in one embodiment, the category is set to movies-on-now. In accordance to this setting, only the discrete intervals that correspond to channels that are currently showing movies are highlighted. Discrete intervals 252, 255, 256, 263, 266, 267, 269, 273, and 275 correspond to channels that are currently showing movies and are highlighted. Other discrete intervals that do not correspond to movies-on-now channels are left un-highlighted. Additionally, it is noted that any or all of the functionalities described prior in FIG. 1 may also be applicable to media selection interface 204 and vice versa.

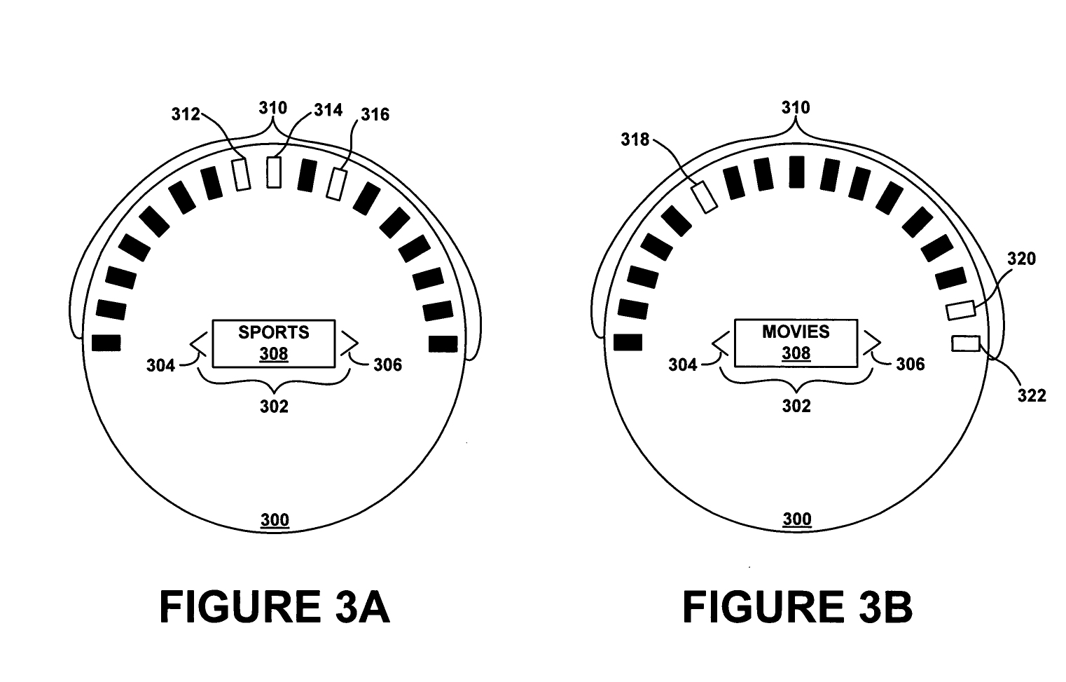

FIGS. 3A and 3B jointly illustrate one implementation of a television selection interface 300 in operation. Television selection interface 300 includes television genre selection mechanism 302, television genre display portion 308 for displaying the selected television genre, a first television genre selection arrow 306 for changing the television genre in a forward direction, a second television genre selection arrow 304 for changing the television genre in a reverse direction, and a channel spectrum 310 showing a number of available television channels. In one embodiment, a user can “dial” through the various channels available on the channel spectrum 310. In one particular embodiment, the television selection interface 300 works in conjunction with a touchscreen device and a user can move her thumb in a generally circular fashion to “dial” through the channels available on the channel spectrum 310.

With reference to FIG. 3A, the sports genre is selected. Channels 312, 314, and 316 are highlighted as channels 312, 314, and 316 are sports channels and are classified under the sports genre. As a user is dialing through channel spectrum 310, non-highlighted channels are automatically bypassed. Hence, a user that desires to quickly browse all available sports channels is not interrupted by non-sports channels.

In one example, a user selects first television genre selection arrow 306 to change the television genre in a forward direction from sports to movies. With reference now to FIG. 3B, the movies genre is selected and channels 318, 320, and 322 are now highlighted as channels 318, 320, and 322 are movie channels and are classified under the movies genre. The television selection interface 300 works in conjunction with a touchscreen device (e.g., a touchscreen television remote control) and a user can “dial” through the channel spectrum 310 to browse all the available movie channels (e.g., channels 318, 320, and 322) and not be interrupted by non-movie channels.

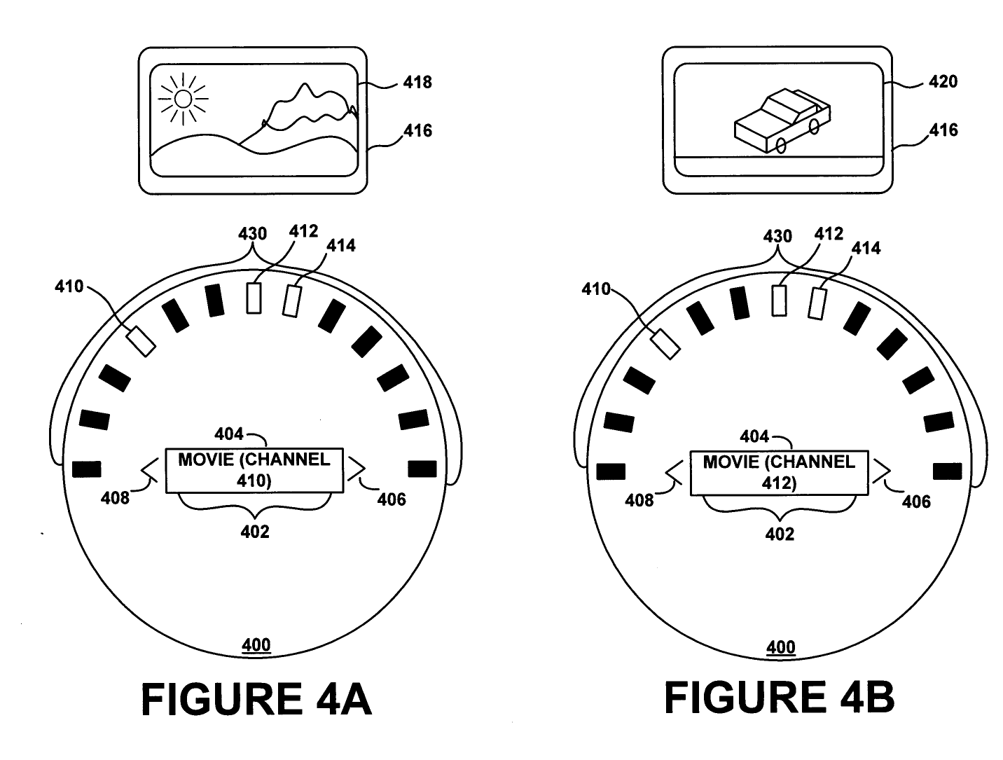

FIGS. 4A and 4B jointly illustrate one implementation of a television selection interface 400 and a display 416 in operation. While FIGS. 3A and 3B provide an illustration of a user changing television genres, FIGS. 4A and 4B provide an illustration of a user changing channels within a particular selected genre. In one example, television selection interface 400 works in conjunction with a touchscreen remote that controls display 416 (e.g., a display integrated with the touchscreen remote, a television display, and/or a computer display.). Specifically, television selection interface 400 is shown on the display surface of the touchscreen remote to facilitate navigation through available television channels. In a different example, television selection interface 400 works in conjunction with a television display. Television selection interface 400 includes television genre selection mechanism 402, display portion 404 for displaying the selected television genre (e.g., movies), a display 416, a first television genre selection arrow 406 for changing the television genre in a forward direction, a second television genre selection arrow 408 for changing the television genre in a reverse direction, and a channel selection spectrum 430 showing a number of available television channels. In one embodiment, a user can scroll through the various channels available on the channel selection spectrum 430. The display portion 404 shows the genre and the channel number within the genre. The display portion shows “movie (channel 410)” to indicate to a viewer that he/she is currently viewing channel 410 of the movie genre.

With reference to FIG. 4A, the viewer has currently selected channel 410 and correspondingly the display 416 is displaying media content 418. With reference to FIG. 4B, as the viewer scrolls to channel 412, the display 416 transitions to and displays media content 420. Also, it is noted that any or all of the functionalities described prior, such as in FIG. 1 and FIG. 2, may also be applicable to media selection interface 400 and vice versa.

Furthermore, as previously mentioned, embodiments are not limited to television content and are equally applicable to other types of media, such as audio media. Thus, a channel selection spectrum can be utilized to navigate through different audio channels.

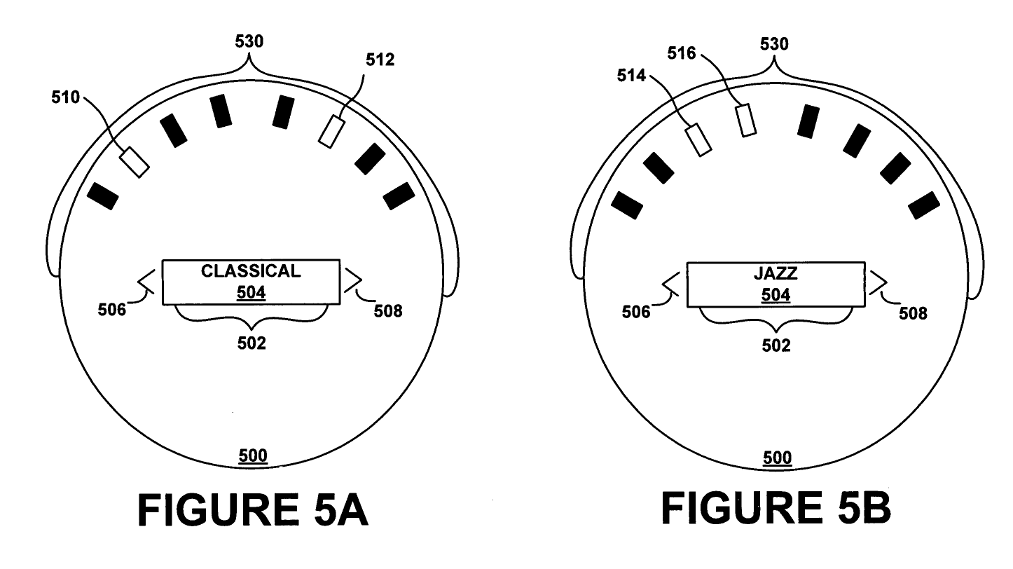

FIGS. 5A and 5B jointly illustrate one implementation of a music selection interface 500 in operation. Music selection interface 500 includes music genre selection mechanism 502, display portion 504 for displaying the selected music genre (e.g., classical), a first music genre selection arrow 508 for changing the music genre in a forward direction, a second music genre selection arrow 506 for changing the music genre in a reverse direction, and a channel selection spectrum 530 showing a number of available music channels. In one embodiment, a user can “dial” through the various channels available on the channel selection spectrum 530. The display portion 504 shows what the user has currently selected. The display portion shows “classical” (as shown in FIG. 5A) to indicate to a listener that he/she is currently listening to a channel of the classical music genre.

With reference to FIG. 5A, the listener has currently selected the classical genre and is listening to channel 510. While the classical genre is selected, channels 510 and 512 are highlighted. To listen to channel 512, the listener simply has to “dial” to channel 512 as shown in FIG. 5A. If the listener desires to listen to music of a different genre, he or she can, in one example, use the first music genre selection arrow 508 to change the genre from classical to jazz. With reference now to FIG. 5B, the user has changed the genre from classical to jazz. Because of this transition, a different set of channels (e.g., channels 514 and 516) are highlighted. While the jazz genre is selected, a user can choose between channels 514 and 516.

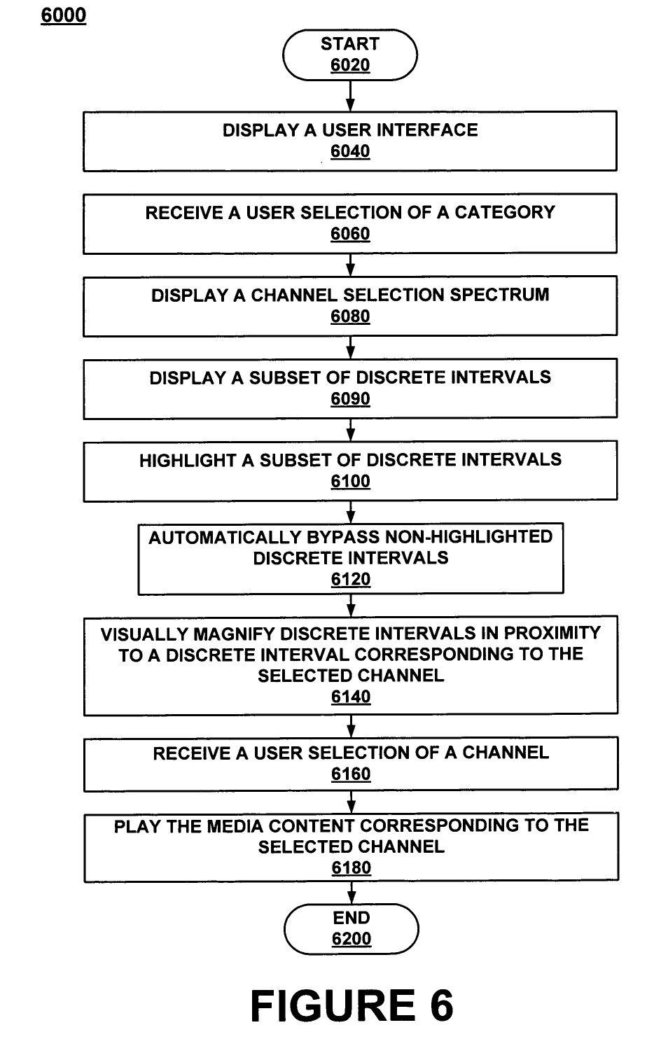

FIG. 6 illustrates an example flowchart 6000 of a method of media selection. Although specific steps are disclosed in flowchart 6000, such steps are exemplary. That is, embodiments are well suited to performing various other or additional steps or variations of the steps recited in flowchart 6000. It is appreciated that the steps in flowchart 6000 can be performed in an order different than presented. Also, not all the steps in flowchart 6000 need to be implemented. At block 6020, the process starts. The method of media selection is applicable to television media as well as music media.

At block 6040, a user interface is displayed. The user interface has a category selection tool (e.g., 106 and 108 of FIG. 1) for selecting a category of a number of categories. In one embodiment, the channel selection spectrum is elliptically shaped and the subset of discrete intervals that correspond to channels of the selected category are situated at different angular positions of the channel selection spectrum. Also, the elliptically shaped channel selection spectrum is configured to interpret radial motion from a user as a command to “dial” through the subset of discrete intervals that correspond to channels of the selected category.

At block 6060, a user selection of a category (e.g., news category) is received. In one example, the selected category includes a number of channels (e.g., news channel 1, news channel 2, . . . , news channel N).

At block 6080, a channel selection spectrum is displayed. In one example, the channel selection spectrum has a circular arc shape, such as the circular arc multimedia asset selection spectrum 102 of FIG. 1. However, it is noted that a channel selection spectrum is not limited to a circular arc shape. In some embodiments, a channel selection spectrum is linear (e.g., linear channel selection spectrum 201 of FIG. 2). In one example, instead of using a radial based motion, users can simply use up/down or left/right motion to navigate through the different available channels. In one embodiment, the channel selection spectrum is divided into a number of discrete intervals in which each discrete interval represents a channel.

At block 6090, a subset of discrete intervals corresponding to the channels of the selected category is displayed. The discrete intervals can be visually represented in different ways. In one embodiment, each discrete interval of the number of discrete intervals is represented by a rectangle (e.g., discrete interval 263 of FIG. 2). A discrete interval can include an icon (e.g., discrete interval 263 of FIG. 2). Also, discrete intervals can be visually represented as lines, such as in FIG. 1.

At block 6100, a subset of discrete intervals is highlighted. The number of discrete intervals represents all the television channels available. When a particular category of the available categories is selected a subset of the number of discrete intervals is highlighted. In one example, 300 discrete intervals are displayed to represent all the television channels available for viewing. When the user selects the movies category, it only highlights 20 channels classified under the movies category and leaves the remaining 280 channels un-highlighted. Also, a channel selection mechanism (e.g., channel selection mechanism 104) enables a user to efficiently navigate through the subset of discrete intervals to browse the channels of the selected category.

At block 6120, non-highlighted discrete intervals representing channels from a non-selected category are automatically bypassed. Furthermore, in one instance, in addition to bypassing discrete intervals representing channels from a non-selected category, other discrete intervals corresponding to user-banned channels are also automatically bypassed. For example, parental control may cause inappropriate channels to be automatically bypassed.

At block 6140, discrete intervals in proximity to a discrete interval corresponding to the selected channel are visually magnified. In one example where the media selection interface is working in conjunction with a touchscreen remote control device, as a user moves his or her finger alone the channel selection spectrum, the discrete intervals in proximity of the user's finger are visually magnified. The visual magnification allows a user to easily see and distinguish between the different channels.

Furthermore, in one embodiment, a first discrete interval of the number of discrete intervals corresponding to a channel playing a first type of media content is visually distinguished from a second discrete interval of the plurality of discrete intervals corresponding to a channel playing a second type of media content. While a certain category is selected, different channels of the same category may correspond to different types of media. While a movies category is selected, a first channel is a television channel showing movies and a second channel is a music channel playing movie soundtracks. The first channel can be assigned a different icon that distinguishes it from the second channel. Specifically, the first channel can be assigned a movie icon and the second channel can be assigned a soundtrack icon.

At block 6160, user selection of a channel (e.g., movie channel 5) is received.

At block 6180, the media content (e.g., Rocky II) corresponding to the user selected channel is played. At block 6200, the process ends.

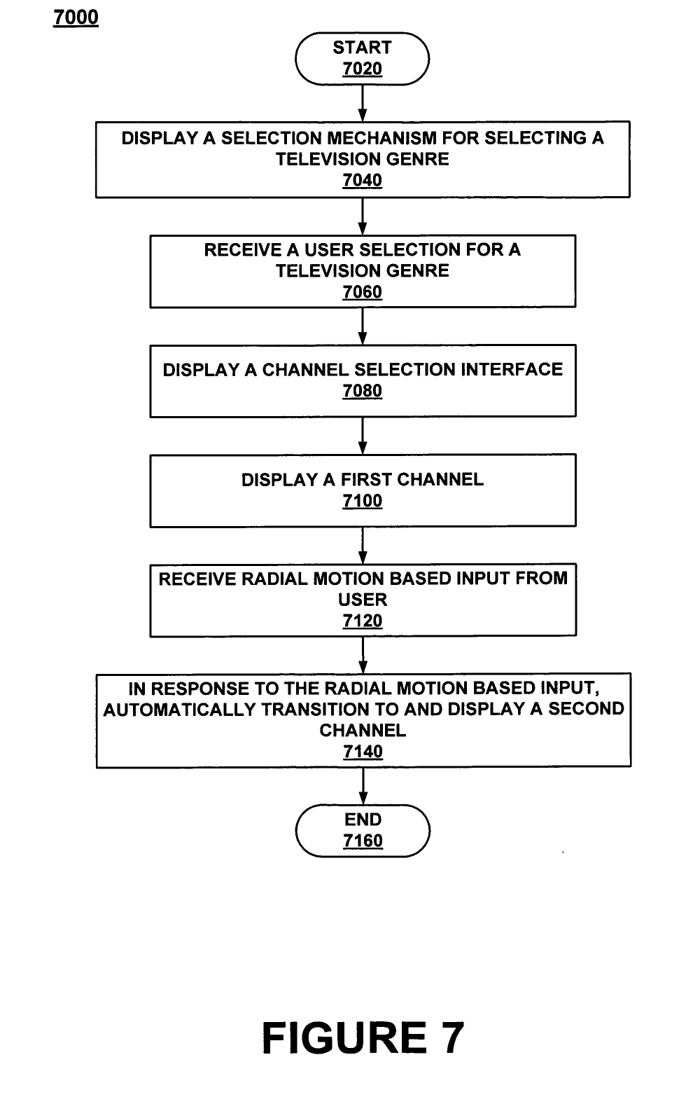

FIG. 7 illustrates an example flowchart 7000 for a method of television channel selection. At block 7020, the process starts. At block 7040, a selection mechanism for selecting a television genre is displayed. The selection mechanism, in one example, can be similar but is not limited to the category selection component 104 of FIG. 1.

At block 7060, a user selection for a television genre is received.

At block 7080, a channel selection interface is displayed. The channel spectrum occupies a portion of the channel selection interface and is divided into a number of discrete sections (e.g., individual lines or blocks that represent channels). In one embodiment, at least one discrete section (e.g., a line) of the number of discrete sections corresponds to a channel of the number of channels of the selected television genre (e.g., movies). The channels of the selected television genre (e.g., news channels) are organized into a number of groups and each group of the number of groups represents a sub-genre (e.g., international news) of the selected television genre.

In one embodiment, a first channel having a first set of metadata may be associated with a second channel having a second set of metadata. Specifically, the first set of metadata may be compared with the second set of metadata to determine if the first channel and the second channel are similar. In one specific example, a first channel has a first metadata that describes the first channel as “category: sports, sub-category: golf.” The second channel has a second set of metadata that describes the second channel as “category: sports, sub-category: baseball.” As the metadata for the first channel and the second channel both relate to sports, the first channel may be associated with the second channel.

At block 7100, a first channel (e.g., sports channel 11) is displayed.

At block 7120, radial motion based input is received from a user. In one example, the channel selection interface is utilized in conjunction with a touchscreen remote control device. Thus, a user can use his or her finger or thumb to provide radial motion based input. A user can “dial” through a channel spectrum by moving his or her finger across the portions of the touchscreen surface that are displaying the channel spectrum. One or more discrete sections (e.g., lines) of the number of discrete sections that corresponds to channels of the selected television genre are highlighted. Also, upon receiving radial motion based input from a user, channels corresponding to non-highlighted discrete sections are automatically bypassed as the user moves his or her finger along the channel spectrum.

At block 7140, in response to the radial motion based input, a second channel is automatically transition to and displayed (Sports Channel 27). At block 7160, the process ends.

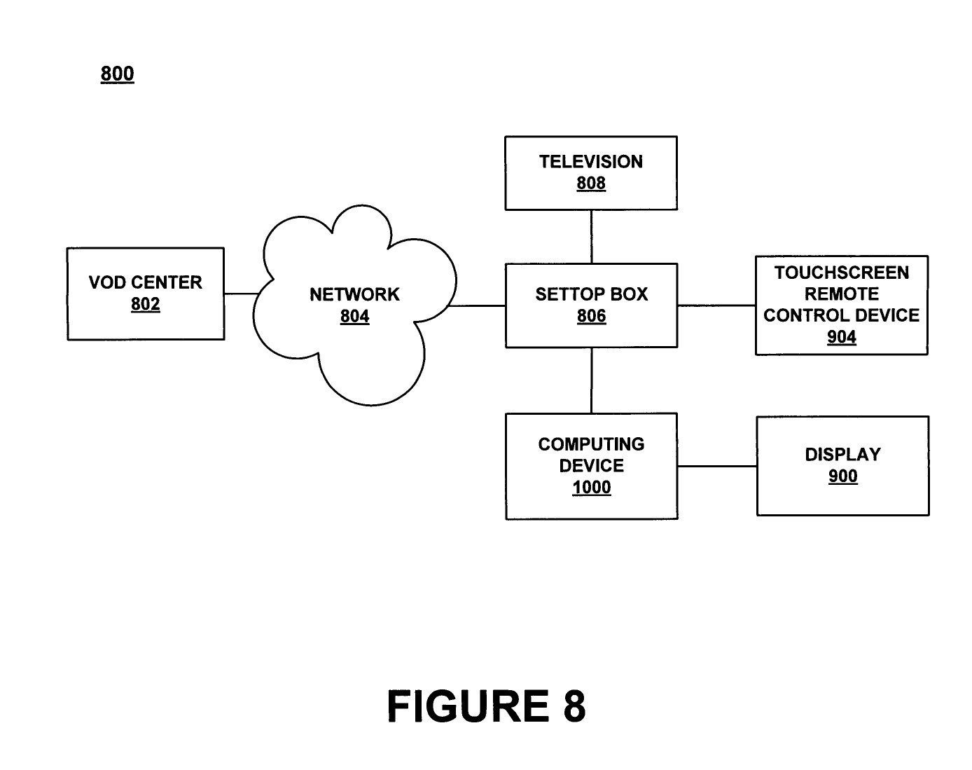

FIG. 8 illustrates an example system 800 for delivering VOD content from a VOD center 802 to a user. System 800 includes a VOD center 802, a network 804, a settop box 806, a television 808, a computing device 1000, a display 900, and a touchscreen remote control device 904. The VOD center 802 is coupled with the settop box 806 via network 804. The settop box 806 can be a digital settop box capable of providing two-way communications on an IP network and decoding incoming video streaming media. Specifically, the settop box 806 can turn the signal received from VOD center 802 into content to be displayed on a screen, such as television 808 and/or display 900. Network 804 can be a VOD service network, such as a hybrid fiber-coaxial network or a fiber optic service network. Also, the network 804 can be an Internet Protocol Television (IPTV) network. Furthermore, the VOD center 802 can include a video library for storing images, a video server, a data server, a processor, and/or a switch.

The settop box 806 is coupled with computing device 1000 and/or television 808. Also, a touchscreen remote control device 904 coupled with the settop box 806 allows a user to interact with the settop box 806.

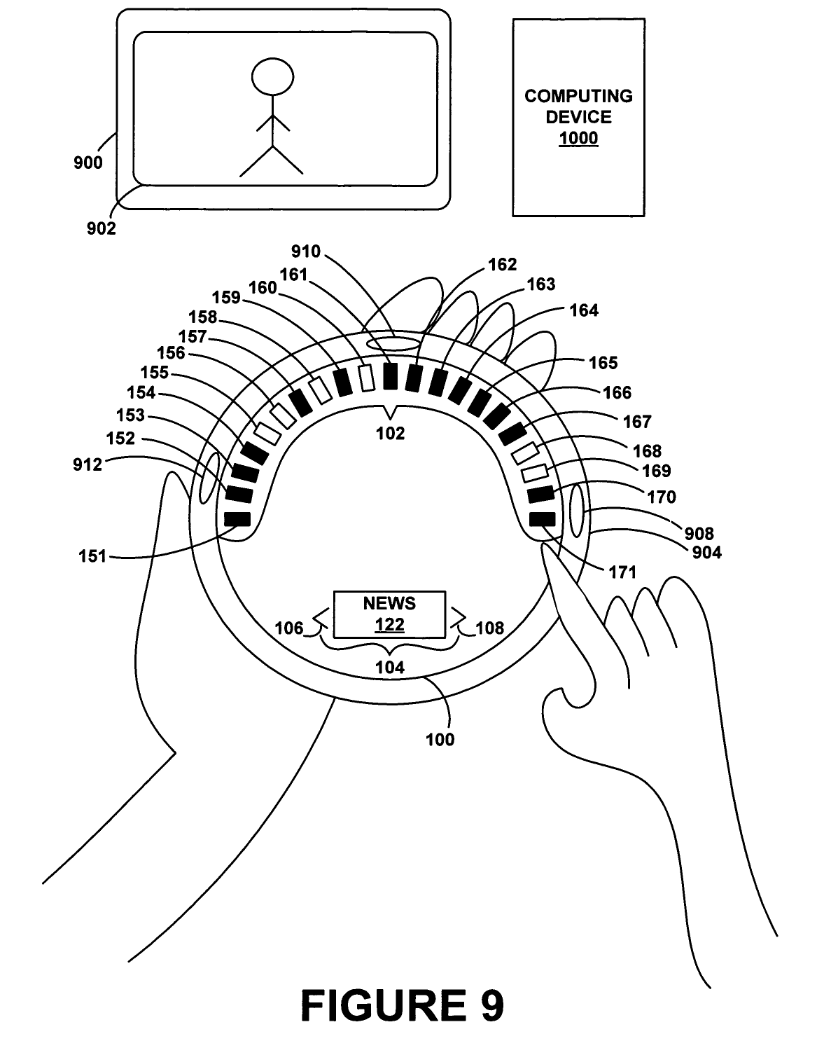

FIG. 9 illustrates one example touchscreen remote control device 904 cooperatively operating with the computing device 1000. With reference to FIG. 9, computing device 1000 is communicatively coupled with display 900 (e.g., a computer display) and touchscreen remote control device 904. The display 900 is displaying media content 902 that corresponds to the currently selected channel. The touchscreen remote control device 904 includes a media selection interface 100 (discussed in detail previously), a button 912, a button 910, and a button 908. The buttons 912, 910, and 908, in one example, are user programmable and can be tailored to perform a variety of functions. As discussed previously, a user can navigate through circular arc multimedia asset selection spectrum 102 to browse the different channels. A user can, in one example, hold the touchscreen device in the user's palm and move his or her finger (or thumb) in a radial direction along the touchscreen remote control device 904 to dial through various channels. However, a touchscreen remote control device 904 is not limited to the shape shown in FIG. 9. In fact, a touchscreen remote control device 904 can be shaped in a variety of ways to suit different needs. In one example, the touchscreen remote control device 904 is configured to work with a linear channel selection spectrum and has a generally rectangular shape. A user may, in one example, move his or her finger in a right/left or up/down direction to scroll through the different channels available on the linear channel selection spectrum.

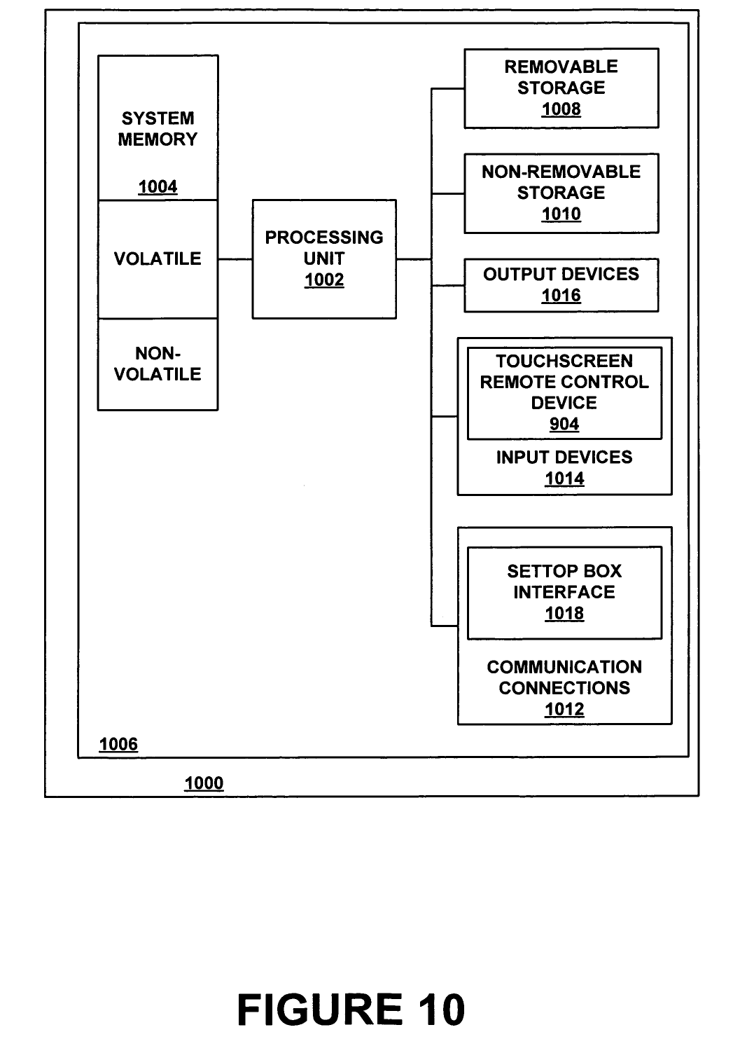

FIG. 10 illustrates an example computing device 1000 for implementing the claimed subject matter. In its most basic configuration, computing device 1000 typically includes at least one processing unit 1002 and memory 1004. Depending on the exact configuration and type of computing device, memory 1004 may be volatile (such as RAM), non-volatile (such as ROM, flash memory . . . etc.) or some combination of the two. This most basic configuration is illustrated in FIG. 10 by dashed line 1006. Additionally, device 1000 may also have additional features/functionality. For example, device 1000 may also include additional storage (removable and/or non-removable) including, but not limited to, magnetic or optical disks or tape. Such additional storage is illustrated in FIG. 10 by removable storage 1008 and non-removable storage 1010. Computer storage media includes volatile and nonvolatile, removable and non-removable media implemented in any method or technology for storage of information such as computer readable instructions, data structures, program modules or other data. Memory 1004, removable storage 1008 and non-removable storage 1010 are all examples of computer storage media. Computer storage media includes, but is not limited to, RAM, ROM, EEPROM. flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 1000. Any such computer storage media may be part of device 1000. Device 1000 may be utilized to execute computer-executable instructions for performing the steps of a media selection application program.

Device 1000 may also contain communications connection(s) 1012 that allow the device to communicate with other devices. In particular, communications connection(s) 1012 includes a settop box interface 1018 that enables device 1000 to communicate with a settop box, such as settop box 806 of FIG. 8. Communications connection(s) 1012 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Device 1000 may also have input device(s) 1014 such as a keyboard, a mouse, a pen, and/or a voice input device. Specifically, input device(s) 1014 includes the touchscreen remote control device 904. Output device(s) 1016 such as a display (e.g., a display integrated with a touchscreen device, a television display, and/or display 900 of FIG. 9), speakers, printer, etc. may also be included. All these devices are well know in the art and need not be discussed at length here.

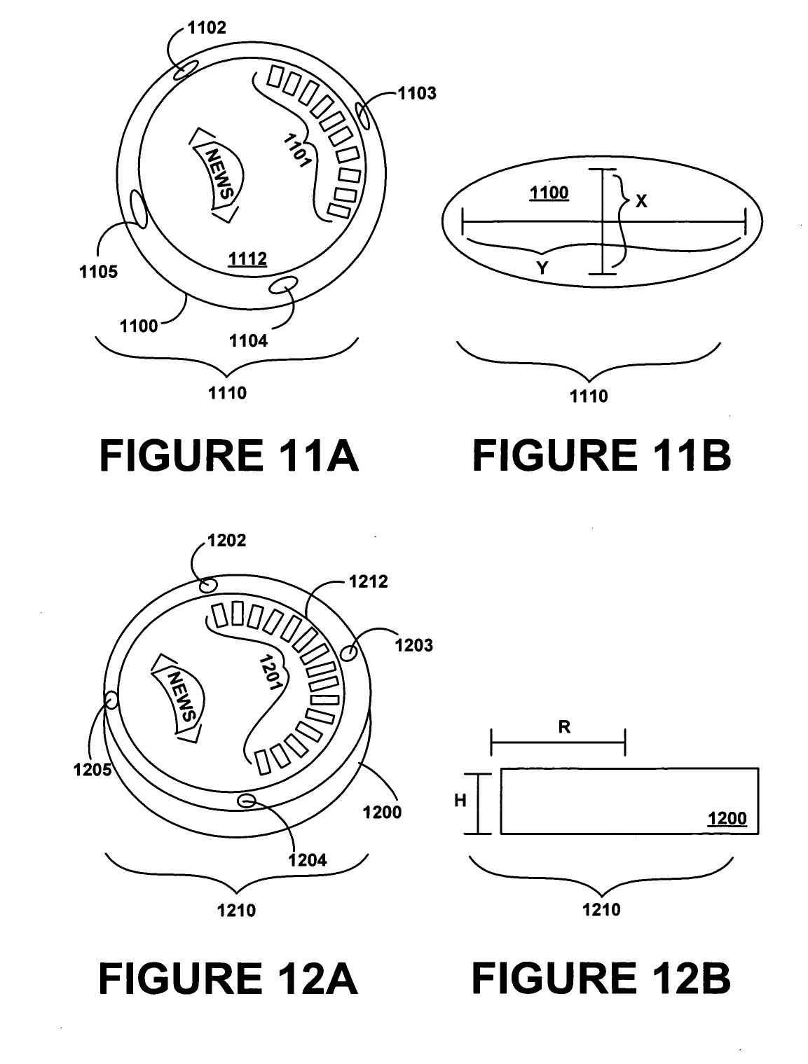

FIGS. 11A and 11B illustrate a perspective view and a side view respectively of an example media selection remote control device 1110. FIG. 11A illustrates a media selection remote control device 1110 having an oblate spheroidal body 1100, a touchscreen 1112, a button 1102, a button 1103, a button 1104, a button 1105, and a media selection spectrum 1101.

The buttons 1102, 1103, 1104, and 1105 are programmable. In one example, a button (e.g., button 1102, 1103, 1104, or 1105), when pressed, activates a set of user preferences. In another example, a button (e.g., button 1102, 1103, 1104, or 1105), when pressed, causes the touchscreen 1112 to display a user customized media selection spectrum (e.g., media selection spectrum 1101). In still another example, if a first user programmable button (e.g., 1102) is pressed, then a first set of user programmable settings corresponding to a first set of media content is displayed on the touchscreen 1112. And if a second user programmable button (1103) is pressed, then a second set of user programmable settings corresponding to a second set of media content is automatically transitioned to and displayed on the touchscreen 1112.

Furthermore, aside from the exterior features, in one embodiment, an integrated circuit resides within said oblate spheroidal body and is disposed to interpret radial-based user inputs received by touchscreen 1112 as commands to navigate through the available media content.

To supplement FIG. 11A, FIG. 11B illustrates a side view of the media remote control device 1110. As one can see in FIG. 11B, the media remote control device 1110 has an elliptical profile. The minor axis is indicated by “X” and the major axis is indicated by “Y”. The oblate spheroidal body 1100 is symmetrical along the minor axis, “X.” Additionally, in some embodiments, the major axis, “Y,” of the oblate spheroidal body is less than 5 inches in length and the minor axis, “X,” of the oblate spheroidal body is less than 3 inches in length.

The size and shape of the oblate spheroidal body 1100, aside from being aesthetically pleasing, is also designed to be ergonomically proper. The oblate spheroidal body 1100 is absent of sharp edges or corners that can cause pain and/or discomfort to a user when held for an extended period of time. Moreover, its circular lines and relative small size allows a user to hold it securely and comfortably.

Furthermore, the edgeless, cornerless, oblate spheroidal shape renders the media remote control device 1110 more impact resistant. As remote controls are often moved about, remote controls are frequently dropped or caused come into contact with various household surfaces. In case such an occurrence happens to the media remote control device 1110, its oblate spheroidal exterior can more effectively distribute the force of the impact when compared with conventional rectangular remote controls. As a result, the shape of media remote control device 1110 helps to protect its internal electronics.

With reference still to FIG. 11A, the touchscreen 1112 forms a portion of the outer surface of the oblate spheroidal body 1100. As shown in FIG. 11A, the touchscreen is generally circular and is aligned with the minor axis of the oblate spheroidal body 1100. However, in other embodiments, the touchscreen 1112 can be shaped differently (e.g., a rectangular touchscreen). The touchscreen 1112 is configured to display a user interface having a media selection spectrum 1101 (or a channel selection spectrum). The media selection spectrum 1101 provides a visual representation of a plurality of media content. The media selection spectrum 1101 can be utilized to represent video content as well as music content. In one specific instance, the media selection spectrum 1101 is utilized to represent a variety of available VOD content. In another instance, the media selection spectrum is utilized to represent available television channels.

And because the media selection remote control device 1110, in one implementation, is intended to receive radial-based input, the touchscreen 1112 is specifically configured to receive radial-based user input from a user. Also, it is important to note that the touchscreen 1112 can be based on a variety of technologies. For example, touchscreen 1112 can be but is not limited to: a resistive touchscreen, a surface wave touchscreen, a capacitive touchscreen, an infrared touchscreen, a strain gauge touchscreen, an optical imaging touchscreen, a dispersive signal technology touchscreen, or an acoustic pulse recognition touchscreen.

The media selection remote control device 1110 has an ergonomic oblate spherioidal shape (also known as a rotationally symmetric ellipsoid) and can be comfortably held by a user with one hand. Once placed in the user's palm, the user can use his/her thumb or finger to interface with the touchscreen 1112 and effectively and effortlessly navigate through a variety of available media content that is present on the media selection spectrum 1101.

More specifically, a user can move his/her thumb or finger along the portions of the touchscreen 1112 displaying the media selection spectrum 1101 to provide radial-based user input and navigate through different media content. The media selection spectrum 1101, in one example, is purposely arc-shaped as to better match a user's natural potential path of motion. A radial-based user input remote device is ergonomically superior to traditional numeric key based input devices and can help reduce repetitive stress injury. This is because the human body is designed to be more tolerant towards rotational movements. As an example, the thumb is more suited for rotational movements and less suited for straight line movements. Consequently, as the media selection remote control device 1110 is designed to receive radial-based input, it is more pleasant to operate then conventional numeric key based input devices.

FIGS. 12A and 12B illustrate a perspective view and a side view respectively of an example media selection remote control device 1210. FIG. 12A illustrates a media selection remote control device 1110 having a circular disk shaped body 1200, a touchscreen 1212, a button 1202, a button 1203, a button 1204, a button 1205, and a media selection spectrum 1201. The buttons 1202, 1203, 1204, and 1205, like buttons 1102, 1103, 1104, and 1105, are programmable.

The media selection remote control device 1210 is similar to media selection remote control device 1110 in functionality. As such, similar functionalities need not be repeatedly discussed in detail here. However, in contrast to media selection remote control device 1110's oblate spheroidal body 1100, the media selection remote control device 1210 has a circular disk shaped body 1200. In one embodiment, the circular disk body has a radius of less than 2.5 inches and a height of less than 2 inches. Also, the touchscreen 1212 is a circular touchscreen and the center of said circular touchscreen 1212 is aligned with the center of the circular disk body 1200.

It is important to note that, notwithstanding the above discussions, media selection remote control device are not limited to the shapes illustrated in FIGS. 11A, 11B, 12A, and 12B. As a matter of fact, media selection remote control device can undertake a variety of shape not expressly illustrated but still retain the functionalities described above.

In the foregoing specification, embodiments have been described with reference to numerous specific details that may vary from implementation to implementation. Thus, the sole and exclusive indicator of what is, and is intended by the applicants to be the claimed subject matter is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A media selection remote control device, comprising:
a body; and
a touchscreen forming a portion of the outer surface of said body, wherein said touchscreen is configured to display a user interface having a media selection spectrum, wherein said media selection spectrum provides a visual representation of a plurality of media content, and wherein said touchscreen is configured to receive radial-based user input.

2. The remote control device as recited in claim 1, wherein said body is an oblate spheroidal body.

3. The remote control device as recited in claim 2, wherein said oblate spheroidal body is a rotationally symmetric ellipsoid.

4. The remote control device as recited in claim 2, wherein said touchscreen is a circular touchscreen, and wherein the center of said circular touchscreen is aligned with the minor axis of said oblate spheroidal body.

5. The remote control device as recited in claim 1, further comprising:
an integrated circuit residing within said body, wherein said integrated circuit is disposed to interpret said radial-based user input as a command to navigate through said plurality of media content.

6. The remote control device as recited in claim 1, further comprising: a user programmable button residing on the outer surface of said body.

7. The remote control device as recited in claim 6, wherein when said user programmable button is pressed causes said touchscreen to display a user customized media selection spectrum.

8. The remote control device as recited in claim 1, further comprising:
a first user programmable button residing on the outer surface of said body, wherein if said first user programmable button is pressed, then a first set of user programmable settings corresponding to a first set of media content is displayed on said touchscreen; and
a second user programmable button residing on the outer surface of said body, wherein if said second user programmable button is pressed, then a second set of user programmable settings corresponding to a second set of media content is automatically transitioned to and displayed on said touchscreen.

9. The remote control device as recited in claim 1, wherein said media selection remote control device is operable with one hand, and wherein said touchscreen is configured to receive radial-based user input from a user's thumb.

10. The remote control device as recited in claim 1, wherein said touchscreen is a resistive touchscreen, a surface wave touchscreen, a capacitive touchscreen, an infrared touchscreen, a strain gauge touchscreen, an optical imaging touchscreen, a dispersive signal technology touchscreen, or an acoustic pulse recognition touchscreen.

11. The remote control device as recited in claim 1, wherein the major axis of said oblate spheroidal body is less than 5 inches, and wherein the minor axis of said oblate spheroidal body is less than 3 inches.

12. A media selection remote control device, comprising:
a circular disk shaped body having an upper surface and a lower surface;
a touchscreen residing on said upper surface, wherein said touchscreen is configured to display a user interface having a media selection spectrum, wherein said media selection spectrum provides a visual representation of a plurality of media content, and wherein said touchscreen is configured to receive radial-based user input,
an integrated circuit residing within said circular disk shaped body, wherein said integrated circuit is disposed to interpret said radial-based user input as a command to navigate through said plurality of media content.

13. The remote control device as recited in claim 1, wherein said circular disk body has a radius of less than 2.5 inches.

14. The remote control device as recited in claim 1, wherein said circular disk body has a height of less than 2 inches.

15. The remote control device as recited in claim 1, wherein said touchscreen is a circular touchscreen, and wherein the center of said circular touchscreen is aligned with the center of said circular disk body.

16. The remote control device as recited in claim 1, further comprising: a user programmable button residing on said upper surface of said circular disk body.

17. The remote control device as recited in claim 5, wherein when said user programmable button is pressed causes said touchscreen to display a user customized media selection spectrum.

18. The remote control device as recited in claim 1, further comprising:
a first user programmable button residing on said upper surface of said circular disk body, wherein if said first user programmable button is pressed, then a first set of user programmable settings corresponding to a first set of media content is displayed on said touchscreen; and
a second user programmable button residing on said upper surface of said circular disk body, wherein if said second user programmable button is pressed, then a second set of user programmable settings corresponding to a second set of media content is automatically transitioned to and displayed on said touchscreen.

19. The remote control device as recited in claim 1, wherein said media selection remote control device is operable with one hand, and wherein said touchscreen is configured to receive radial-based user input from a user's thumb.

20. A media selection remote control device, comprising:
an oblate spheroidal body;
a touchscreen means for displaying a user interface having a media selection spectrum and for receiving radial-based user input, wherein said touchscreen means forms a portion of the outer surface of said oblate spheroidal body, and wherein said media selection spectrum provides a visual representation of a plurality of media content;
a processor means for interpreting said radial-based user input as a command to navigate through said plurality of media content.
